(19) United States
(12) Patent Application Publication
(10) Pub. No.: US 2018/0044214 A1
(43) Pub. Date: Feb. 15, 2018

(54) IMPINGEMENT BURNERS, CONDITIONNG CHANNELS INCLUDING SAME, AND METHODS

(71) Applicant: JOHNS MANVILLE, Denver, CO (US)

(72) Inventor: Aaron Morgan Huber, Castle Rock, CO (US)

(21) Appl. No.: 15/236,121

(22) Filed: Aug. 12, 2016

(51) Int. Cl. C03B 5/235; F23D 14/78; F23D 14/32; C03B 5/04; F23D 14/22

(52) U.S. Cl. CPC C03B 5/2356; C03B 5/04; C03B 5/2353; F23D 14/22; F23D 14/32; F23D 14/78; C03B 2211/22; C03B 2211/60

(57) ABSTRACT

Fluid-cooled impingement burners have an external conduit and a first internal conduit substantially concentric therewith forming a first annulus for passing a cooling fluid. A second internal conduit forms a second annulus between the first and second internal conduits. A burner tip body defined by an inner wall, an outer wall, and a half-toroid crown, the inner wall connected to the first internal conduit, the outer wall connected to the external conduit, the inner wall defining a central flow passage for a combustible mixture. A third internal conduit generally concentric with the external conduit and positioned between the external and the first internal conduits, a first end of the third internal conduit extending into but not connecting with the half-toroid crown. A first end of the second internal conduit recessed is below the half-toroid crown, and the position of the first ends of the second and third internal conduits delay combustion of fuel with the oxidant.

### CROSS-REFERENCE TO RELATED APPLICATIONS

### BACKGROUND INFORMATION

### Technical Field

The present disclosure relates to systems and methods for reducing foam or its impact during manufacture of glass products, mineral wool, rock wool, and other non-metallic inorganic materials using submerged combustion melters.

### Background Art

Submerged combustion melting (SCM) involves melting glass-forming materials, mineral wool forming materials, rock wool forming materials, and other non-metallic inorganic feedstock materials to produce molten materials by passing oxygen, oxygen-air mixtures or air along with a liquid, gaseous fuel, or particulate fuel directly into a molten or semi-molten pool of material, usually through burners submerged in a melt pool. The introduction of high flow rates of oxidant and fuel into the molten material, and the expansion of the gases cause rapid melting of the feedstock and much turbulence. However, one drawback to submerged combustion is the tendency of the molten material to foam. The foam may stabilize in a top layer when the molten mass is routed through conditioning and/or distribution channels/systems downstream of the submerged combustion melter. The foam layer may impede the ability to apply heat to the glass using combustion burners, and may also impede the rate at which further bubbles in the melt rise and thus effect expulsion of the bubbles and mass flow rate of the melt in channels downstream of the SCM. In extreme cases, the foam generated may interfere with the traditional energy application methods employed, which may cause systems to require shutdown, maintenance and may result in a process upset. Attempts to reduce the foam problem through process adjustments and impingement burners have not met with complete success in reducing foam to an acceptable amount or acceptable burner life.

It would be an advance in the glass manufacturing art if foam could be reduced, or the effect of the foam reduced, during glass manufactured using a submerged combustion melter and methods.

### SUMMARY

In accordance with the present disclosure, systems and methods are described which reduce or overcome one or more of the above problems.

A first aspect of the disclosure is a fluid-cooled impingement combustion burner comprising (consisting essentially of, or consisting of):

a burner body comprising an external conduit and a first internal conduit substantially concentric with the external conduit, the external conduit comprising a first end, a second end, and a longitudinal bore having a longitudinal axis, the first internal conduit comprising a first end, a second end, and a longitudinal bore having a longitudinal axis, the external conduit and first internal conduit forming a first annulus for passing a cooling fluid there between,

a second internal conduit substantially concentric with the external conduit, the second internal conduit comprising a first end, a second end, and a longitudinal bore having a longitudinal axis, and configured to form a second annulus between the first and second internal conduits, the burner body comprising fuel and oxidant inlet ports near the second ends of the conduits;

a burner tip body defined by an inner wall, an outer wall, and a half-toroid crown connecting the inner and outer walls, the inner wall connected to the first end of the first internal conduit, the outer wall connected to the first end of the external conduit, the inner wall of the burner tip body defining a generally central flow passage configured to pass a combustible mixture therethrough;

a third internal conduit generally concentric with the external conduit and positioned between the external and the first internal conduits,

a first end of the third internal conduit extending into but not connecting with the half-toroid crown;

a first end of the second internal conduit recessed below the half-toroid crown,

wherein the position of the first ends of the second and third internal conduits are configured to delay combustion of fuel when fuel is passed through the second internal conduit and oxidant is passed through the second annulus.

A second aspect of the disclosure is system comprising (consisting of, or consisting essentially of) a submerged combustion melter (SCM) fluidly connected to a flow channel downstream of the SCM (sometimes referred to herein as a conditioning channel) without any intervening chambers, channels, or devices, except in certain embodiments a melter exit structure and a transition section between the melter exit structure and the flow channel, the flow channel devoid of submerged combustion burners and comprising a floor, a roof, and a sidewall structure connecting the floor and roof defining an internal space; and one or more fluid-cooled impingement combustion burners of the first aspect in either the roof, the sidewall structure, or both.

A third aspect of the disclosure is a method of producing molten inorganic product comprising flowing the molten inorganic product through the flow channel of the second aspect and impinging foam in the flow channel using the one or more fluid-cooled impingement combustion burners.

A fourth aspect is a method comprising:

melting glass-forming materials in a submerged combustion melter comprising a floor, a roof, and a wall structure connecting the floor and roof, the melter comprising one or more submerged combustion burners and a molten glass outlet;

producing an initial foamy molten glass having a density and comprising bubbles, at least some of the bubbles forming a bubble layer on top of the foamy molten glass; and

routing at least a portion of the foamy molten glass and bubble layer into a downstream component fluidly connected to the melter, the downstream component comprising a flow channel, a downstream component roof, and a downstream component wall structure connecting the downstream component flow channel and downstream component roof; and

routing combustion products from at least one non-submerged fluid-cooled impingement combustion burner of the first aspect positioned in the downstream component roof and/or downstream component wall structure to impact at least a portion of bubbles in the bubble layer on the foamy molten glass with sufficient force and/or heat to burst at least some of the bubbles.

Systems and methods of the disclosure will become more apparent upon review of the brief description of the drawings, the detailed description of the disclosure, and the claims that follow.

### BRIEF DESCRIPTION OF THE DRAWINGS

The manner in which the objectives of the disclosure and other desirable characteristics can be obtained is explained in the following description and attached drawings in which:

FIG. 1 is a schematic perspective view of one embodiment of a fluid-cooled impingement burner of this disclosure;

FIG. 2 is a schematic cross-sectional view of the burner of FIG. 1 along the line A-A;

FIG. 3 is a schematic cross-sectional view of the top portion of the burner of FIG. 1;

FIG. 4 is a schematic perspective view of another embodiment of a fluid-cooled impingement burner of this disclosure;

FIG. 5 is a schematic plan view of one embodiment of a conditioning channel apparatus and system in accordance with this disclosure;

FIG. 6 is a schematic cross-sectional view along line C-C of FIG. 5;

FIGS. 7 and 8 are cross-sectional views along line B-B of FIG. 1 illustrating schematically two embodiments of conditioning channels in accordance with the present disclosure; and

FIGS. 9 and 10 are logic diagrams of two method embodiments of the present disclosure.

It is to be noted, however, that the appended drawings are not to scale and illustrate only typical embodiments of this disclosure, and are therefore not to be considered limiting of its scope, for the disclosure may admit to other equally effective embodiments.

### DETAILED DESCRIPTION

In the following description, numerous details are set forth to provide an understanding of the disclosed burners, burner panels, SCMs, and methods. However, it will be understood by those skilled in the art that the apparatus and methods covered by the claims may be practiced without these details and that numerous variations or modifications from the specifically described embodiments may be possible and are deemed within the claims. For example, wherever the term “comprising” is used, embodiments and/or components where “consisting essentially of” and “consisting of” are also explicitly disclosed herein and are part of this disclosure. An example of “consisting essentially of” may be with respect to the composition of a burner conduit: a conduit consisting essentially of carbon steel means there may be a minor portions or trace amounts of metals, oxides, and other chemical species that are noble metals, such chromium, platinum, and the like, and a conduit consisting essentially of noble metal may have trace amounts of iron, iron oxides, carbon, and other metal oxides. An example of “consisting of” may be a burner made up of components that are one or more carbon steels and no noble metals or ceramic materials, or conduits made up of only noble metals. Another example of “consisting essentially of” may be with respect to particulate feedstock that consists essentially of inorganic feedstock, meaning that a minor portion, perhaps up to 10, or up to 5, or up to 4, or up to 3, or up to 2, or up to 1 wt. percent may be organic. An example of methods and systems using the transition phrase “consisting of” includes those where only burners having liquid-cooled jackets are used, with no gas-cooled jackets, or vice versa. The term “comprising” and derivatives thereof is not intended to exclude the presence of any additional component, step or procedure, whether or not the same is disclosed herein. In order to avoid any doubt, all compositions, apparatus, systems, and methods claimed herein through use of the term “comprising” may include any additional component, step, or procedure unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed. The term “or”, unless stated otherwise, refers to the listed members individually as well as in any combination.

All references to the Periodic Table of the Elements herein shall refer to the Periodic Table of the Elements, published and copyrighted by CRC Press, Inc., 2003. Also, any references to a Group or Groups shall be to the Group or Groups reflected in this Periodic Table of the Elements using the IUPAC system for numbering groups. Unless stated to the contrary, implicit from the context, or customary in the art, all parts and percentages are based on weight and all test methods are current as of the filing date hereof. The acronym “ASTM” means ASTM International, 100 Barr Harbor Drive, PO Box C700, West Conshohocken, Pa., 19428-2959 USA.

All numbers disclosed herein are approximate values, regardless whether the word “about” or “approximate” is used in connection therewith. They may vary by 1%, 2%, 5%, and sometimes, 10 to 20%. Whenever a numerical range with a lower limit, RL and an upper limit, RU, is disclosed, any number falling within the range is specifically disclosed. In particular, the following numbers within the range are specifically disclosed: R=RL+k*(RU-RL), wherein k is a variable ranging from 1% to 100% with a 1% increment, i.e., k is 1%, 2%, 3%, 4%, 5%, . . . , 50%, 51%, 52%, . . . , 95%, 96%, 97%, 98%, 99%, or 100%. Moreover, any numerical range defined by two R numbers as defined in the above is also specifically disclosed.

All U.S. patent applications and U.S. patents referenced herein are hereby explicitly incorporated herein by reference. In the event definitions of terms in the referenced patents and applications conflict with how those terms are defined in the present application, the definitions for those terms that are provided in the present application shall be deemed controlling. All percentages herein are based on weight unless otherwise specified.

As explained briefly in the Background, one drawback to submerged combustion is the tendency of the molten material to foam, either from glass-forming reactions, reactions pertaining to transformation of mineral and rock feedstocks into mineral wool and rock wool, combustion products, or combinations of these. Foams, especially glass foams, may stabilize in a top layer when the molten mass is routed through equipment downstream of the submerged combustion melter, such as forehearths, conditioning channels, distribution channels, and the like. The foam layer may impede the ability to apply heat to the molten or semi-molten material using combustion burners in the melter and in such downstream equipment, and may also impede the rate at which further bubbles in the melt rise and thus effect expulsion of the bubbles and mass flow rate of the melt in the channels. In extreme cases, the foam generated may interfere with the traditional energy application methods employed, in particular non-submerged low momentum combustion burners, which may cause systems to require shutdown, maintenance and may result in a process upset. Attempts to reduce the foam problem through process adjustments and impingement burners have not met with complete success in reducing foam to an acceptable amount or acceptable burner life. In certain instances, accretions (build-up of solid or partially solidified material) on impingement burner tips causes the flame from such burners to be deflected, reducing foam destruction efficiency as a melting campaign progresses. In drastic cases such flame deflection may cause melting or destruction of refractory linings of the SCM or flow channel.

Applicant has discovered fluid-cooled impingement burners, systems and methods that may reduce or eliminate such problems.

Various terms are used throughout this disclosure. “Impingement” means that flames or combustion products emanate from a burner tip above and strike an area or layer of foam floating on a molten mass of glass or other material being melted, and this flame or combustion product may emanate from a burner in a roof or sidewall of a melter or flow channel. “Impingement” or “auxiliary” burners as used herein are non-submerged combustion burners, and are either roof-mounted or wall-mounted, and in certain embodiments may be adjusted to deliver combustion products or oxidant either to foam layers at angles ranging from about 0 degrees (parallel to the foam layer) to about 90 degrees (perpendicular to the foam layer). “Submerged” as used herein means that combustion gases emanate from burner tips under the level of the molten material; submerged combustion (“SC”) burners may be floor-mounted, wall-mounted, roof-mounted, or in melter embodiments comprising more than one submerged combustion burner, any combination thereof (for example, two floor mounted burners and one wall mounted burner). “Wall” includes sidewalls and end wall unless otherwise noted.

The terms “foam” and “foamy” include froths, spume, suds, heads, fluffs, fizzes, lathers, effervesces, layer and the like. The term “bubble” means a thin, shaped, gas-filled film of molten material. The bubble shape may be spherical, hemispherical, rectangular, ovoid, and the like. Gas in the gas-filled bubbles may comprise oxygen or other oxidants, nitrogen, argon, noble gases, combustion products (including but not limited to, carbon dioxide, carbon monoxide, NOₓ, SOₓ, H₂S, and water), reaction products of glass-forming ingredients (for example, but not limited to, sand (primarily SiO₂), clay, limestone (primarily CaCO₃), burnt dolomitic lime, borax and boric acid, and the like, or reaction products of other feedstocks being melted, such as rock and minerals. Bubbles may include solids particles, for example soot particles, either in the film, the gas inside the film, or both.

As used herein the term “combustion gases” means substantially gaseous mixtures of combusted fuel, any excess oxidant, and combustion products, such as oxides of carbon (such as carbon monoxide, carbon dioxide), oxides of nitrogen, oxides of sulfur, and water. Combustion products may include liquids and solids, for example soot and unburned liquid fuels.

“Oxidant” as used herein includes air and gases having the same molar concentration of oxygen as air, oxygen-enriched air (air having oxygen concentration of oxygen greater than 21 mole percent), and “pure” oxygen, such as industrial grade oxygen, food grade oxygen, and cryogenic oxygen. Oxygen-enriched air may have 50 mole percent or more oxygen, and in certain embodiments may be 90 mole percent or more oxygen. Oxidants may be supplied from a pipeline, cylinders, storage facility, cryogenic air separation unit, membrane permeation separator, or adsorption unit.

The term “fuel”, according to this disclosure, means a combustible composition comprising a major portion of, for example, methane, natural gas, liquefied natural gas, propane, atomized oil or the like (either in gaseous or liquid form). Fuels useful in the disclosure may comprise minor amounts of non-fuels therein, including oxidants, for purposes such as premixing the fuel with the oxidant, or atomizing liquid fuels. As used herein the term “fuel” includes gaseous fuels, liquid fuels, flowable solids, such as powdered carbon or particulate material, waste materials, slurries, and mixtures or other combinations thereof. When the fuel comprises gaseous fuel, the gaseous fuel may be selected from the group consisting of methane, natural gas, liquefied natural gas, propane, carbon monoxide, hydrogen, steam-reformed natural gas, atomized oil or mixtures thereof.

The sources of oxidant and fuel may be one or more conduits, pipelines, storage facility, cylinders, or, in embodiments where the oxidant is air, ambient air. Oxygen-enriched oxidants may be supplied from a pipeline, cylinder, storage facility, cryogenic air separation unit, membrane permeation separator, or adsorption unit such as a vacuum swing adsorption unit.

Various conduits, such as, oxidant and fuel conduits of burners or burner panels of the present disclosure, spacers, burner tip walls and crowns, feedstock supply conduits, and SCM exhaust conduits may be comprised of metal, ceramic, ceramic-lined metal, or combination thereof. Suitable metals include carbon steels, stainless steels, for example, but not limited to, 306 and 316 steel, as well as titanium alloys, aluminum alloys, and the like. High-strength materials like C-110 and C-125 metallurgies that are NACE qualified may be employed for burner body components. (As used herein, “NACE” refers to the corrosion prevention organization formerly known as the National Association of Corrosion Engineers, now operating under the name NACE International, Houston, Texas.) Use of high strength steel and other high strength materials may significantly reduce the conduit wall thickness required, reducing weight of the conduits and/or space required for conduits. In certain locations, precious metals and/or noble metals (or alloys) may be used for portions or all of these conduits. Noble metals and/or other exotic corrosion and/or fatigue-resistant materials such as platinum (Pt), ruthenium (Ru), rhodium (Rh), palladium (Pd), silver (Ag), osmium (Os), iridium (Ir), and gold (Au); alloys of two or more noble metals; and alloys of one or more noble metals with a base metal may be employed. In certain embodiments a protective layer or layers or components may comprise an 80 wt. percent platinum/20 wt. percent rhodium alloy attached to a base metal using brazing, welding or soldering of certain regions, as further explained in Applicant's co-pending U.S. patent application Ser. No. 14/778,206, filed Sep. 18, 2015. In certain embodiments carbon steel burner conduits may be preferred as a low cost option, it being understood that these conduits most likely will have to be “advanced” more often than noble metal burner conduits, or noble metal tipped burner conduits.

The choice of a particular material is dictated among other parameters by the chemistry, pressure, and temperature of fuel and oxidant used and type of melt to be produced with certain feedstocks. The skilled artisan, having knowledge of the particular application, pressures, temperatures, and available materials, will be able design the most cost effective, safe, and operable heat transfer substructures, feedstock and exhaust conduits, burners, burner panels, and melters for each particular application without undue experimentation.

“Conduits” need not have a circular cross-section. SCMs need not have a rectangular cross-section or floor plan. The term “hydraulic diameter” means D_{H}=4A/P, where A is the cross-sectional area, and P is the wetted perimeter of the cross-section. Hydraulic diameter is mainly used for calculations involving turbulent flow, and for calculating Reynolds number, Re=ρuL/μ, where
L=D_{H},
μ=viscosity,
ρ=density, and
u=velocity.
   Secondary flows (for example, eddies) can be observed in non-circular conduits and vessels as a result of turbulent shear stress in the fluid flowing through the conduit or vessel experiencing turbulent flow. Hydraulic diameter is also used in calculation of heat transfer in internal flow problems. For a circular cross-section conduit, D_{H} equals the diameter of the circle. For an annulus, D_{H} equals Dₒ−Dᵢ, where Dₒ and Dᵢ are the annulus outer diameter and inner diameter, respectively. For a square conduit having a side length of a, the D_{H} equals a. For a fully filled conduit whose cross section is a regular polygon, the hydraulic diameter is equivalent to the diameter of a circle inscribed within the wetted perimeter. “Turbulent conditions” means having a Re>4000, or greater than 5000, or greater than 10,000, or greater than 20,000 or higher. The phrase “the oxidant experiences a flow that is turbulent” means the oxidant is flowing in turbulent manner as it leaves the annulus and for a short distance (1 or 2 cm) thereafter so that eddies are maintained and contribute to the bubble bursting effect. The phrase “turbulent conditions in substantially all of the material being melted” means that the SC burners and the SCM are configured so that there may be some regions near the wall and floor of the SCM where the material being melted will be in transient or laminar flow as measured by Re, but the majority (perhaps greater than 51%, or greater than 55%, or greater than 6%, or greater than 65%, or greater than 70%, or greater than 75%, or greater than 80% of the material being melted will be experiencing turbulent flow. Transient flow is defined as 2300<Re<4000, and laminar flow is defined as Re<2300. The phrase “ejected portions of melted material” means portions of the material being melted (or completely molten material) that actually separate from the splash zone and travel generally upward toward the SCM ceiling, or toward the SCM walls above the splash zone, and even up into the exhaust structure, then either solidify or drip back down into the melt, or fall back into the melt after an arcuate path upward, reaching a maximum, then falling back into the melt, as in projectile motion.

Suitable materials for refractory fluid-cooled panels and SCM and flow channel refractory liners are fused zirconia (ZrO₂), fused cast AZS (alumina-zirconia-silica), rebonded AZS, or fused cast alumina (Al₂O₃). The geometry of the burner, SCM, or flow channel, and composition of molten material to be produced may dictate the choice of a particular material, among other parameters. Such refractory lining materials may include ceramics such as, but not limited to, alumina and silicon nitride, refractory materials such as, but not limited to, chrome-containing or zircon-based refractory metals, and noble metals, or mixtures or combinations thereof.

The term “fluid-cooled” means use of any coolant fluid (heat transfer fluid) to transfer heat away from the equipment in question, other than ambient air that resides naturally on the outside of the equipment. For example, portions of or the entire panels of sidewall structure, floor, and ceiling of the SCM and flow channels, skimmers, baffles, portions or all of heat transfer substructures used to preheat feedstock (for example nearest the melter), portions of feedstock supply conduits, and portions of SC burners, and the like may require fluid cooling. The terms “cooled” and “coolant” may include use of any heat transfer fluid and may be any gaseous, liquid, slurry, or some combination of gaseous, liquid, and slurry compositions that functions or is capable of being modified to function as a heat transfer fluid. Gaseous heat transfer fluids may be selected from air, including ambient air and treated air (for example, air treated to remove moisture), inorganic gases, such as nitrogen, argon, and helium, organic gases such as fluoro-, chloro- and chlorofluorocarbons, including perfluorinated versions, such as tetrafluoromethane, and hexafluoroethane, and tetrafluoroethylene, and the like, and mixtures of inert gases with small portions of non-inert gases, such as hydrogen. Heat transfer liquids may be selected from liquids that may be organic, inorganic, or some combination thereof, for example, salt solutions, glycol solutions, oils and the like. Other possible heat transfer fluids include steam (if cooler than the expected glass melt temperature), carbon dioxide, or mixtures thereof with nitrogen. Heat transfer fluids may be compositions comprising both gas and liquid phases, such as the higher chlorofluorocarbons. Certain SCMs and method embodiments of this disclosure may include fluid-cooled panels such as disclosed in Applicant's U.S. Pat. No. 8,769,992.

Certain fluid-cooled impingement combustion burners of this disclosure may comprise (or consist essentially of, or consist of):

a burner body comprising an external conduit and a first internal conduit substantially concentric with the external conduit, the external conduit comprising a first end, a second end, and a longitudinal bore having a longitudinal axis, the first internal conduit comprising a first end, a second end, and a longitudinal bore having a longitudinal axis, the external conduit and first internal conduit forming a first annulus for passing a cooling fluid there between,

a second internal conduit substantially concentric with the external conduit, the second internal conduit comprising a first end, a second end, and a longitudinal bore having a longitudinal axis, and configured to form a second annulus between the first and second internal conduits, the burner body comprising fuel and oxidant inlet ports near the second ends of the conduits;

a burner tip body defined by an inner wall, an outer wall, and a half-toroid crown connecting the inner and outer walls, the inner wall connected to the first end of the first internal conduit, the outer wall connected to the first end of the external conduit, the inner wall of the burner tip body defining a generally central flow passage configured to pass a combustible mixture therethrough;

a third internal conduit generally concentric with the external conduit and positioned between the external and the first internal conduits,

a first end of the third internal conduit extending into but not connecting with the half-toroid crown;

a first end of the second internal conduit recessed below the half-toroid crown,

wherein the position of the first ends of the second and third internal conduits are configured to delay combustion of fuel when fuel is passed through the second internal conduit and oxidant is passed through the second annulus.

In certain embodiments, the first and second internal conduits may have internal and external radii selected such that a velocity ratio of fuel to oxidant ranges from about 0.25 to about 2.5, or from about 1.0 to about 2.0, or from about 1.5 to about 1.9, when fuel is directed through the second internal conduit and oxidant is directed through the second annulus, and the oxidant experiences a flow that is turbulent. Any and all ranges of velocity ratio of fuel to oxidant in between about 0.25 and 2.5 are considered within the present disclosure, including about 0.5 to about 1.95; about 0.5 to about 1.76; about 0.5 to about 1.07; about 0.5 to about 1.0; about 0.5 to about 0.75; about 1.0 to about 1.75;

about 1.5 to about 1.95; about 1.5 to about 1.83; about 1.5 to about 1.74; about 1.45 to about 1.9; about 1.3 to about 2.25; about 1.35 to about 2.15; about 1.3 to about 1.35; about 1.2 to about 1.85; and about 1.2 to about 1.9.

In certain fluid-cooled impingement combustion burner embodiments the first end of the second internal conduit may be positioned adjacent a position where the inner wall of the half-toroid crown connects with the first end of the first inner conduit. In certain fluid-cooled impingement combustion burner embodiments the first ends of the first and second internal conduits may be positioned identically along the longitudinal axis. In certain fluid-cooled impingement combustion burner embodiments the half-toroid crown may have a height of less than 1 inch (2.5 cm), the height measured from where the inner wall is connected to the first end of the first internal conduit, and the outer wall is connected to the first end of the external conduit. In certain fluid-cooled impingement combustion burner embodiments the half-toroid crown may have a crown longitudinal cross-section selected from the group consisting of hemispherical, trapezoidal, triangular, inverted triangular, irregular, and rectangular. In certain fluid-cooled impingement combustion burner embodiments the inner and outer walls of the burner tip body may extend beyond the first end of the second internal conduit. In certain fluid-cooled impingement combustion burner embodiments each conduit may consist of a material having a wear rate that is more than noble metals when used as an impingement burner. In certain fluid-cooled impingement combustion burner embodiments the material may be selected from the group consisting of ceramic materials, non-noble metals, and combinations thereof. In certain fluid-cooled impingement combustion burner embodiments the non-noble metal may be carbon steel. In certain fluid-cooled impingement combustion burner embodiments the external conduit may be noble metal and one or more of the inner conduits may be a non-noble metal material. In certain fluid-cooled impingement combustion burner embodiments the external conduit may be secured in a burner panel. In certain fluid-cooled impingement combustion burner embodiments the conduits may be configured to be movable axially in unison.

In certain fluid-cooled impingement combustion burner embodiments the crown may comprise at least one physical convolution sufficient to increase surface area and fatigue resistance of the crown compared to a half-toroid crown of the same composition lacking the at least one physical convolution. In certain fluid-cooled impingement combustion burner embodiments the at least one crown physical convolution may be selected from the group consisting of at least one generally radial crown physical convolution extending away from the generally central flow passage, and at least one generally non-radial crown physical convolution. In certain fluid-cooled impingement combustion burner embodiments the at least one generally non-radial crown physical convolution may be selected from the group consisting of at least one generally circumferential crown physical convolution, a generally spiral crown physical convolution, at least one randomly positioned convolution, and at least one non-randomly positioned convolution. In certain fluid-cooled impingement combustion burner embodiments the burner tip body crown may comprise a plurality of generally radial physical convolutions extending away from the generally central flow passage. In certain fluid-cooled impingement combustion burner embodiments the plurality of generally radial physical convolutions may form a series of alternating ridges and troughs. In certain fluid-cooled impingement combustion burner embodiments the crown half-toroid may have a crown longitudinal cross-section selected from the group consisting of hemispherical, trapezoidal, triangular, inverted triangular, irregular, and rectangular. In certain fluid-cooled impingement combustion burner embodiments the series of alternating ridges and troughs may form a crown radial cross-section selected from the group consisting of, hemispherical, trapezoidal, triangular, sinusoidal, irregular, rectangular, and sawtooth. In certain fluid-cooled impingement combustion burner embodiments the at least one randomly positioned convolution may comprise a plurality of randomly spaced and randomly shaped depressions. In certain fluid-cooled impingement combustion burner embodiments the at least one non-randomly positioned convolution may comprise a plurality of non-randomly spaced and non-randomly shaped depressions selected from the group consisting of a single row of oblique oval depressions, a single row of chevron depressions, a double row of oblique oval depressions, and combinations thereof. In certain fluid-cooled impingement combustion burner embodiments the at least one generally circumferential crown physical convolution may comprise at least one convolution positioned at the connection of the burner tip body to the external and first internal conduits.

Certain methods may comprise (or consist essentially of, or consist of):

melting glass-forming materials in a submerged combustion melter comprising a floor, a roof, and a wall structure connecting the floor and roof, the melter comprising one or more submerged combustion burners and a molten glass outlet;

producing an initial foamy molten glass having a density and comprising bubbles, at least some of the bubbles forming a bubble layer on top of the foamy molten glass; and

routing at least a portion of the foamy molten glass and bubble layer into a downstream component fluidly connected to the melter, the downstream component comprising a flow channel, a downstream component roof, and a downstream component wall structure connecting the downstream component flow channel and downstream component roof; and

routing combustion products from at least one non-submerged fluid-cooled impingement combustion burner of this disclosure positioned in the downstream component roof and/or downstream component wall structure to impact at least a portion of bubbles in the bubble layer on the foamy molten glass with sufficient force and/or heat to burst at least some of the bubbles.

Certain methods may comprise adjusting one or more of the fluid-cooled impingement combustion burners with respect to direction of flow of their combustion products. Adjustment may be via automatic, semi-automatic, or manual control. Certain system embodiments may comprise a burner mount that mounts the fluid-cooled impingement combustion burner in the wall structure or roof of the flow channel comprising a refractory, or refractory-lined ball joint. Other burner mounts may comprise rails mounted in slots in the wall or roof. In yet other embodiments the fluid-cooled impingement combustion burners may be mounted outside of the downstream flow channel, on supports that allow adjustment of the combustion products flow direction. Useable supports include those comprising ball joints, cradles, rails, and the like.

In certain systems and methods the downstream flow channel may be selected from the group consisting of a distribution channel, a conditioning channel, and a forehearth.

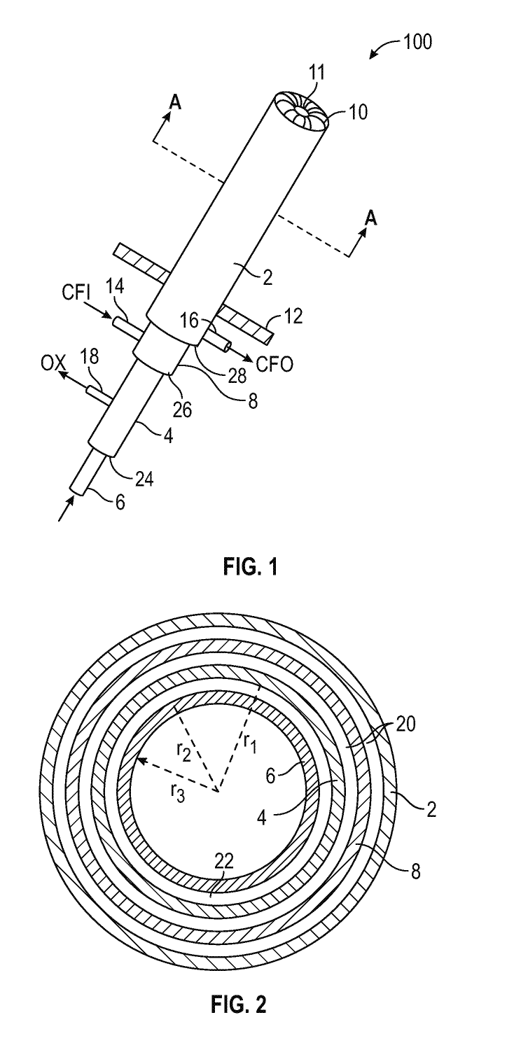

Specific non-limiting apparatus, system and method embodiments in accordance with the present disclosure will now be presented in conjunction with FIGS. 1-10. The same numerals are used for the same or similar features in the various figures. In the views illustrated in FIGS. 1-8, it will be understood in each case that the figures are schematic in nature, and certain conventional features are not illustrated in order to illustrate more clearly the key features of each embodiment.

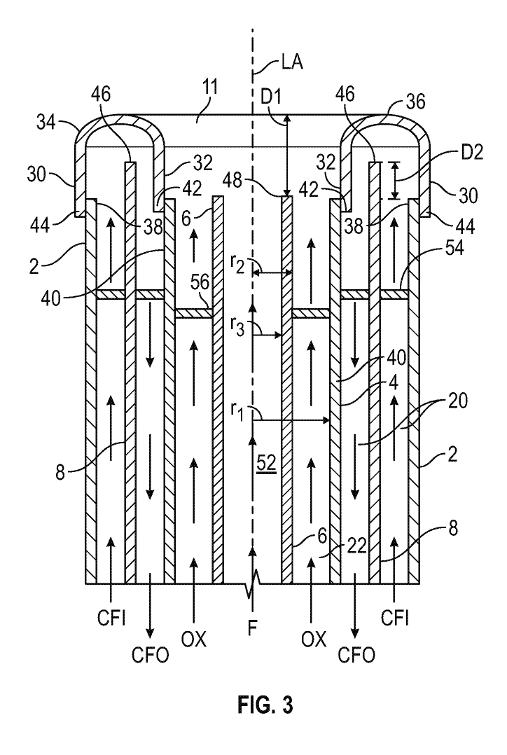

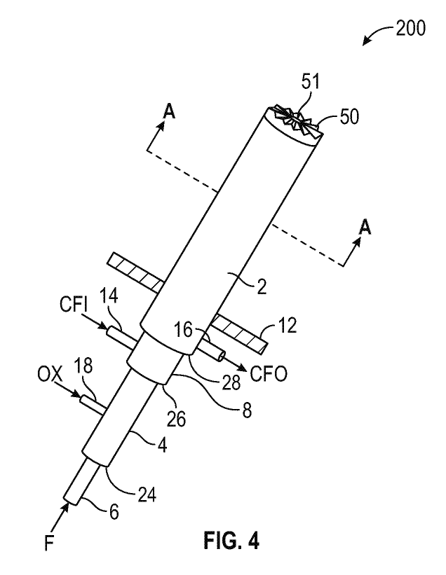

FIG. 1 is a schematic perspective view of one embodiment 100 of a fluid-cooled (preferably liquid-cooled) impingement combustion burner useful in systems and methods of this disclosure. FIG. 2 is a schematic cross-sectional view of burner 100 of FIG. 1 along the line A-A, and FIG. 3 is a schematic longitudinal cross-section of an upper portion of burner 100. Burner embodiment 100 includes an external conduit 2, and first, second, and third internal conduits 4, 6, and 8, respectively. Burner embodiment 100 further includes a half-toroid burner tip 10 that defines a substantially central through passage 11. Burner embodiment 100 is illustrated secured in a panel 12, although panel 12 may not be necessary in every embodiment. Conduits 14, 16 for coolant fluid inlet (“CFI”) and coolant fluid outlet (“CFO”) are illustrated, it being understood that these may be reversed in certain embodiments. An oxidant (“OX”) inlet conduit 18 allows a supply of oxidant to be connected to first internal conduit 4. A plate 24 seals a second end of first internal conduit 4 about second internal conduit 6. Similar end plates 26, 28 seal second end of third internal conduit about first internal conduit 4, and a second end of external conduit 2 about third internal conduit 8, respectively. Fuel (“F”) enters a second end of second internal conduit 6.

Referring now to FIG. 2, FIG. 2 illustrates the burner of FIG. 1 in cross-section along the line A-A of FIG. 1, illustrating a first or primary annulus 20 for coolant fluid bisected by third internal conduit 8, and a second annulus 22 for oxidant. Also depicted in FIG. 2 are radii r₁, r₂, and r₃, with r₁ defined as the internal radius of first internal conduit 4, r₂ being the external radius of second internal conduit 6, and r₃ being the internal radius of second internal conduit 6. The difference between these radii, r₁-r₂, is an important parameter in the burners of the present disclosure, for this difference largely dictates the oxidant velocity in the second annulus 22, along with the supply pressure of the oxidant and the value of r₃, which in turn largely dictates the value of fuel velocity through second internal conduit 6, along with supply pressure of fuel. For constant fuel and oxidant supply pressures, and constant value of r₃, a smaller value of r₁-r₂ would mean a smaller value of ratio of fuel to oxidant velocity, since the oxidant velocity would increase while the fuel velocity would remain the same. Similarly, for constant fuel and oxidant supply pressures, and constant value of r₁-r₂, a larger value of r₃ would mean a smaller value of ratio of fuel to oxidant velocity, since the fuel velocity would decrease while the oxidant velocity would remain the same.

Referring now to FIG. 3, burner 100 has a longitudinal axis “LA”, and burner tip 10 includes a crown 34 having a top surface 36, an outer wall 30 having a lower end 44, an inner wall 32 having a lower end 42. A first end 38 of external conduit 2 is connected to lower end 44 of outer crown wall 30, and a first end 40 of first internal conduit 4 is connected to lower end 42 of inner crown wall 32, the connections being made by brazing, welding, friction fitting or other manner such as described in Applicant's co-pending U.S. patent application Ser. No. 14/785,325, filed Oct. 17, 2015. FIG. 3 also illustrates schematically first annulus 20, second annulus 22 (sometimes referred to as the “oxidant annulus”), and fuel passage 52 through second internal (fuel) conduit 6. Fuel passage 52 exits into generally central flow passage 11 formed by inner wall 32 of the burner tip crown. Still referring to FIG. 3, first end 46 of third internal conduit 8 extends into crown 34 a distance D2 above the first end 48 of second internal conduit 6, while first end 48 of second internal conduit 6 is recessed a distance D1 from the tip of crown 36. The values of D1 and D2 are important parameters of burners of this disclosure, since a smaller value of D1 delays combustion of fuel emanating from second internal conduit 6, and a larger value of D2 provides a higher velocity of coolant fluid between first end 46 of third internal conduit 8 and crown 34, increasing heat transfer (cooling inner crown wall 32 more) and further delaying combustion of fuel with oxidant. This is counter-intuitive, since most burners seek to increase combustion efficiency, even preheating fuel and oxidant. However, the inventor has found that delaying combustion decreases formation of accretions on crown 34 and inner wall 32, which can lead to deflection of flame or combustion products (or oxidant) from burners used as foam impingement burners, where such deflection is undesirable. D1 may range from about 0.25 to about 2.0 inches (about 0.64 to about 5.1 cm), or from about 0.75 to about 1.5 inch (about 1.9 to about 3.8 cm). D2 depends on the shape of half-toroid burner tip 10, but may be from 0.25 to 0.75 times the length of D1.

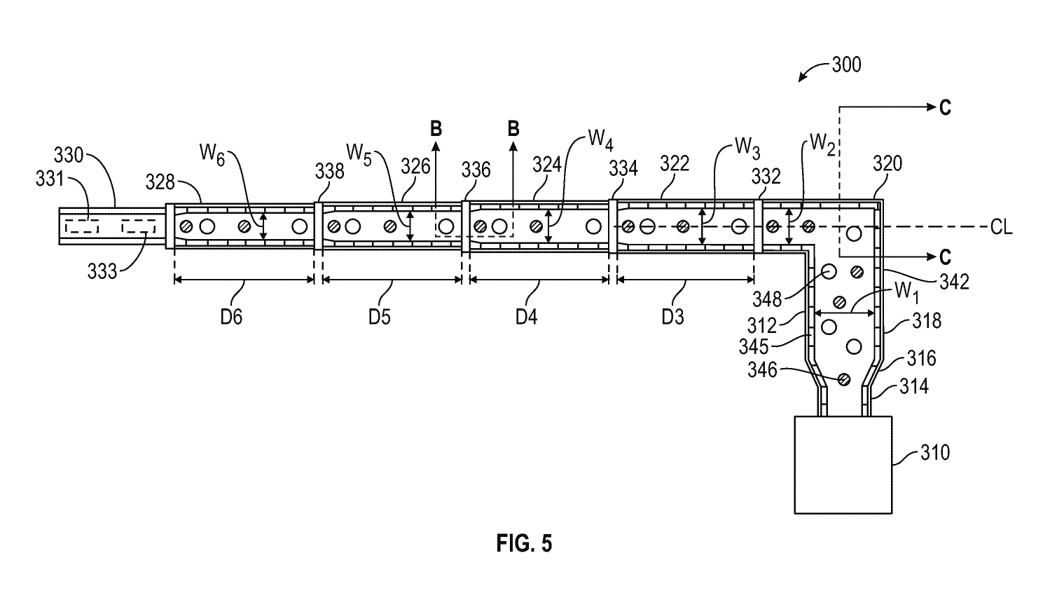

FIG. 4 illustrates schematically another embodiment 200 of fluid-cooled combustion burner in accordance with the present disclosure, embodiment 200 differing from embodiment 100 only in the shape of the burner tip crown 50. The crown 50 still defines a generally central flow passage 51, however, the crown shape comprises at least one physical convolution sufficient to increase surface area and fatigue resistance of the crown compared to a half-toroid crown of the same composition lacking the at least one physical convolution. Burner tip crown 50 in embodiment 200 comprises a plurality of generally radial physical convolutions extending away from the generally central flow passage 51 forming a series of alternating ridges and troughs. More crown shapes are disclosed and described in Applicant's co-pending U.S. patent application Ser. No. 14/785,327, filed Oct. 17. 2015.

Fuel conduit 6 has a fuel exit end (first end) 48 and an inlet end (second end) that may have threads for fitting a bushing thereon including a quick connect/disconnect feature, allowing a hose of other source of fuel to be quickly attached to and detached from the bushing.

Spacers 54 may be provided spaced about 120 degree apart in the primary annulus 20, and a second set of spacers 56 also may be provided spaced about 120 degrees apart in the primary annulus. Spacers 54, 56 provided strength to the burners, as well as help to stabilize the flame emanating from the burners.

Both fluid-cooled impingement combustion burner embodiments 100 and 200 illustrated schematically in FIGS. 1-4 are high momentum burners. For example, embodiments 100 and 200 may each comprise nominal stainless steel Schedule 40 pipes for conduits 6 and 4, their nominal size selected so that they may be machined or have cladding added thereto so that the ratio of fuel velocity to oxidant velocity emanating from the first ends thereof is 0.5 or lower. The selection of conduit schedule dictates the annular distance between the OD of the conduit 12 and the internal diameter (ID) of the conduit, and therefore the radial length of spacers 56. Any arrangement that produces the desired ratio of fuel to oxidant velocities will be suitable, and within the skills of the skilled artisan in possession of this disclosure.

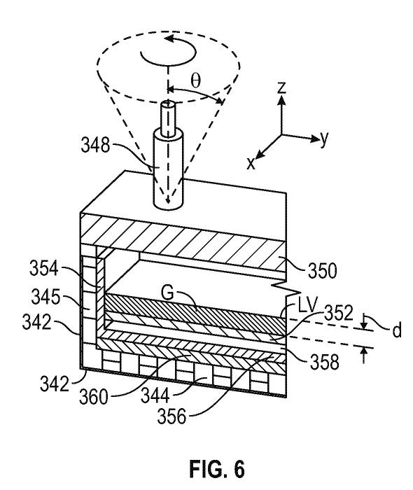

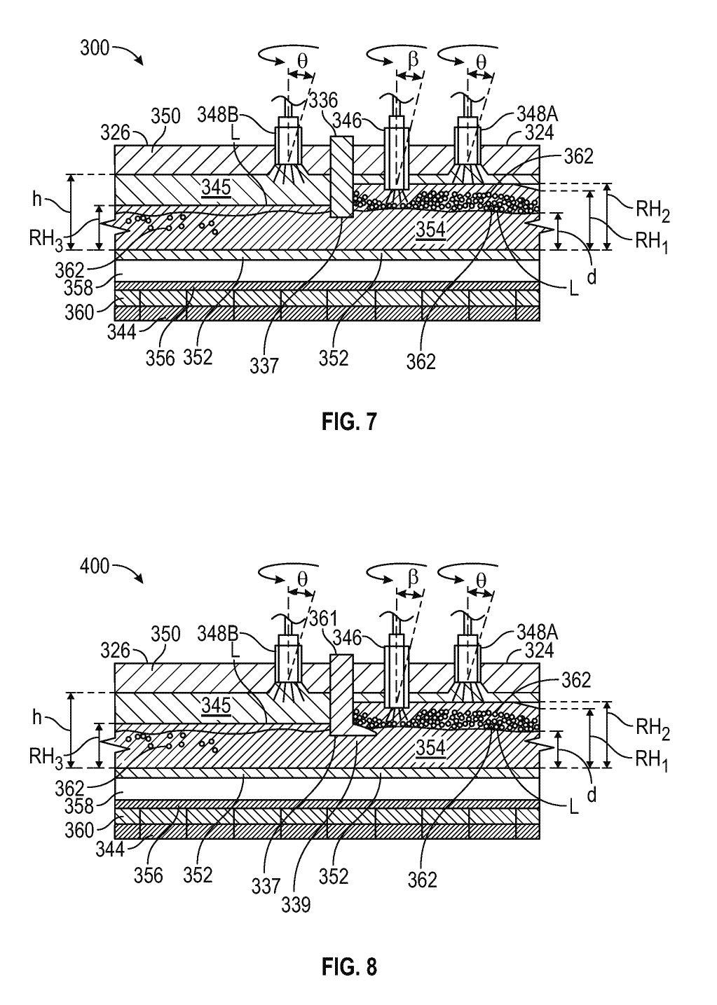

FIG. 5 is a schematic plan view, partially in cross-section, of one embodiment 300 of an apparatus and system of this disclosure. Illustrated schematically is a submerged combustion melter 310 fluidly and mechanically connected to a first conditioning channel section 312 through an exit structure 314 and a transition section 316. Exit structure may be, for example, but not limited to, a fluid-cooled exit structure as described in Applicant's U.S. Pat. No. 9,145,319. First conditioning channel section 312 comprises first and second subsections 318 and 320 in embodiment 300. First channel section 312 includes a roof and floor (both not illustrated in FIG. 5, but illustrated in FIG. 6), and a sidewall structure comprised of an outer metal shell 342, non-glass-contact brick or other refractory wall 344, and glass-contact refractory as further described in context of FIG. 6. First section 312 of embodiment 300 is configured to promote a change of direction of flow of the molten mass of glass of 90 degrees in passing from first subsection 318 through second subsection 320. In various embodiments, the change of direction varies from between about 30 degrees to about 90 degrees.

Still referring to FIG. 5, the conditioning channel of embodiment 300 includes several sections, a second section 322, third section 324, fourth section 326, and fifth section 328 arranged in series, each section having a roof, floor, and sidewall structure connecting its roof and floor, and defining a flow channel for conditioning molten glass flowing there through. Sections 322, 324, 326, and 328 are divided by a series of skimmers, first skimmer 332, second skimmer 334, third skimmer 336, and fourth skimmer 338, each extending generally substantially vertically downward a portion of a distance between the roof and floor of the channel, with a final skimmer 340 positioned between fifth channel section 328 and a forehearth 330. The number of sections and the number of skimmers may each be more or less than five. Forehearth 330, which is not considered a part of the disclosure, may have one or more forming outlets denoted by dashed boxes 331, 333, on its underneath side, such as bushings, gob cutters, and the like, that are known in the art.

The conditioning channel of embodiment 300 includes one or more fluid-cooled impingement combustion burners, denoted strictly by position for clarity as solid darkened circles 346, positioned upstream of each skimmer 332, 334, 336, 338, and 340 in the roof to burst at least some foamed material retained behind the skimmers and floating on top of a molten mass of glass flowing in the flow channel by heat and/or direct impingement thereon. As noted elsewhere herein, fluid-cooled impingement combustion burners 346, may alternately or additionally be positioned in section sidewall structures, or both in section roofs and section sidewall structures. In embodiment 300, a majority of fluid-cooled impingement combustion burners 346 are positioned along a centerline “CL” of the flow channel in the roof of each section, but this is not necessarily so in all embodiments and embodiment 300 includes at least two fluid-cooled impingement combustion burners 346 that are not so positioned in channel first subsection 318.

The conditioning channel of embodiment 300 also includes one or more low momentum (heating) combustion burners, denoted strictly by position for clarity as open circles 348, positioned immediately downstream of each skimmer 332, 334, 336, 338, and 340 in the roof of each section to transfer heat to the molten mass of glass without substantial interference from the foamed material. As noted elsewhere herein, low momentum burners 348, also referred to as non-impingement burners or heating burners, may alternately or in addition be positioned in section sidewall structures, or both in section roofs and section sidewall structures. In embodiment 300, a majority of low momentum combustion burners 348 are positioned along a centerline “CL” of the flow channel in the roof of each section, but this is not necessarily so in all embodiments, and embodiment 300 includes at least four low momentum burners 348 that are not so positioned in channel first subsection 318 and second subsection 320.

Referring again to FIG. 5, in embodiment 300 first subsection 318 has a flow channel W₁ width greater than a flow channel width W₂ of second subsection 320. In embodiment 300, each of the plurality of sections 322, 324, 326, and 328 has a flow channel width W₃, W₄, W₅, W₆, wherein W₃>W₄>W₅>W₆. If N represents the Nth flow channel section in the plurality of sections, in certain embodiments W₁ >W₂ >W₃ >. . . W_{N}. It is preferred that the flow channel width W be as wide as possible to promote long residence times for fining and large surface area for foam to collect (rise from within the molten glass and collect behind skimmers), however, this must be balanced against cost of constructing larger footprint apparatus and systems. Width W may range from about 100 inches (about 250 cm) near the SC melter 310, down to about 10 inches (about 25 cm) near the discharge from the last skimmer 340, or from about 90 inches (about 230 cm) near the SC melter 310 down to about 12 inches (about 30 cm) near the discharge from skimmer 340.

In embodiment 300 skimmers are separated along a longitudinal length of the flow channel by separation distances D3, D4, D5, and D6 as illustrated schematically in FIG. 5 of at least about 5 feet (152 cm), wherein the separation distance may be the same or different from section to section. In certain embodiments the distances D3, D4, D5, and D6 may be greater than or equal to about 5 feet (152 cm) and less than or equal to about 15 feet (456 cm).

FIG. 6 is a schematic perspective, partial cross-sectional view along line C-C of embodiment 300 of FIG. 5, illustrating the sidewall structure of each section has sufficient glass-contact refractory 354 to accommodate the operating depth or level “LV” of molten mass of glass other material being produced “G”, wherein it is understood that level LV denotes only the general level of liquid molten glass other material being produced, and not the foam floating or accumulating thereon. In certain embodiments, sidewall 345 includes glass-contact refractory 354 able to accommodate molten glass depth “d” of no greater than about 10 inches (25.4 cm), in certain other embodiments no greater than about 5 inches (12.7 cm). As illustrated schematically in FIG. 6, the floor of each section may comprise a metal shell 342, a non-glass contact brick layer 344, a non-glass contact refractory support or insulating layer 360, a series of refractory layers 356, 358, and 352, wherein layer 352 may be a glass-contact refractory layer or a refractory layer compatible with the another material being produced. Alternatively, in embodiment 300, layers 352 and 356 may define an open layer or cavity 358 for flow of a heating (or cooling) fluid. The thicknesses of materials or layers 342, 344, 345, 350, 352, 354, 356, 358 and 360 depend on many factors, including the type of glass or other material being produced, the material properties of the materials themselves, temperature and temperature homogeneity of molten glass desired or targeted, and the like.

Referring again to FIG. 6, illustrated schematically is a low momentum burner 348, illustrating that burners 346 and/or 348 may be adjusted or positioned to direct their flames and/or combustion products in a variety of directions, denoted generally by a cone angle θ, which may vary from 0 to about 45 degrees, in any direction from 0 to 360 degrees about the z-axis as denoted by the circular arrow about the longitudinal centerline of burner 48 (an x-y-z set of coordinate axis is provided for reference).

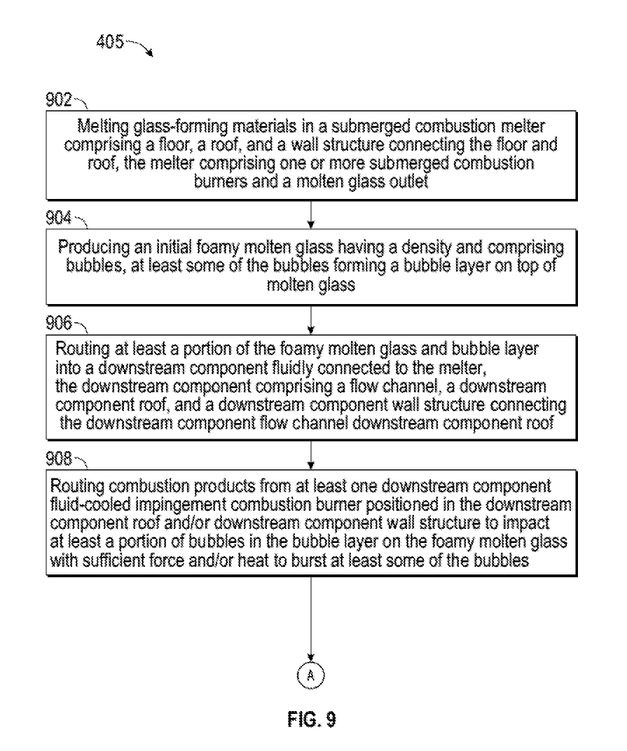

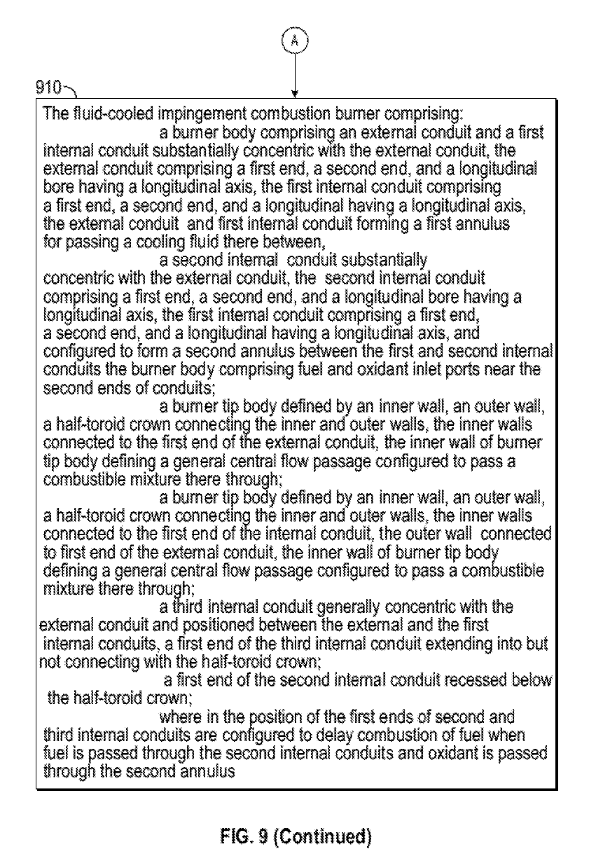

An important aspect of the present disclosure is illustrated schematically in FIGS. 7 and 8, which are cross-sectional views along line B-B of FIG. 5. FIGS. 7 and 8 illustrate schematically two embodiments 300 and 400 of conditioning channels in accordance with the present disclosure wherein the sidewall structures and floors of each section may be comprised of glass-contact refractory (or other refractory compatible with the material being produced, such as molten rock for producing items therefrom, such as rock wool, or molten minerals for producing mineral wool) extending at least 2 inches (5.1 cm) above operating level LV of molten glass upstream of each skimmer. Illustrated in FIGS. 7 and 8 is skimmer 336 positioned generally between sections 324 and 326. Skimmer 336 has a distal end 337 that extends a sufficient fraction of the distance “h” (distance from roof to floor of a flow channel) so that distal end 337 is just below molten glass level LV. Each section N has a height “h_{N}”, and each skimmer may have a distal end 337 extending downward at least 0.5×h_{N}; in any case the distal end of each skimmer is designed to extend below operating level LV of the molten mass. A fluid-cooled impingement combustion burner 346 is illustrated impinging on bubbles 362, destroying some of the bubbles, while non-impinging low momentum burners 348A and 348B supply heat. Note that burner 348B is positioned to provide heat to the material without substantial interference from bubbles 362. Fluid-cooled impingement combustion burners 346 may vary the position of their flame and/or combustion product in the same or similar manner as burner 348 illustrated schematically in FIG. 6, that is, angle β may vary from 0 to about 45 degrees, in any direction from 0 to 360 degrees about the z-axis. Note there are three heights of glass-contact refractory in this embodiment. Glass-contact refractory height RH₁ exemplifies the height of the glass-contact refractory in transition, increasing from a height such as height RH₃ to height RH₂, where height RH₂ is the height of glass-contact refractory in regions of high bubble volume. The height RH₂ is the height that may extend 2 inches or even 18 inches above the level of the molten glass L. The presence of this “extra” glass-contact refractory allows accommodation of foam floating on the molten glass in those regions. In certain embodiments wherein foaming is a particular problem, the sidewall structure's glass-contact refractory may extend at least 2 inches (5.1 cm) above the operating level of molten mass of material being melted LV upstream of each skimmer, and in certain embodiments at least 18 inches (46 cm) above the operating level LV of molten material upstream of each skimmer.

FIG. 8 illustrates schematically in cross-section an embodiment 400 similar to embodiment 300. Skimmer 361 of embodiment 400 includes a distal end 337 having a wing, ridge, or other appendage 339 protruding generally away from the body of skimmer 361 in the upstream direction. The purpose of embodiment 400 and skimmer 361 is primarily to emphasize that skimmers need not all be the same in a particular channel embodiment, and secondarily to illustrate other shapes of skimmers that may be useful in apparatus, systems, and methods of this disclosure. Other, structurally and functionally equivalent shapes and features for skimmers will become apparent to those of skill in this art having the benefit of hindsight of this disclosure.

It should be understood that embodiment 300 is only one example of many possible downstream components and channel shapes. Suitable shaped channel or trough of refractory material may have any longitudinal shape (straight, L-shaped, curved, for example S-shaped), and may have one or more parallel and/or series arranged regions. Conditioning channel 300 may have any lateral (cross-sectional) shape, such as rectangular, oval, round, V-shaped, U-shaped, and the like. Depth of channel 300 may vary, but exemplary embodiments may have a depth that is commensurate with SC melter depth, and such that the foamy molten glass will be able to move into the channel. The cross-sectional shape may be the same or different along the length of the channel.

The flow rate of the foamy or reduced foam molten material through channel 300 will in turn depend on many factors, including the dimensions of channel sections, size of SC melter 310, whether or not there is a weir or like device (such as a skimmer hanging from a roof), temperature of the melts, viscosity of the melts, and like parameters, but in general the flow rate of molten material in channel 300 may range from about 0.5 lb./min to about 5000 lbs./min or more (about 0.23 kg/min to about 2300 kg/min or more), or from about 10 lbs./min to about 500 lbs./min (from about 4.5 kg/min to about 227 kg/min), or from about 100 lbs./min to 300 lbs./min (from about 45 kg/min to about 136 kg/min).

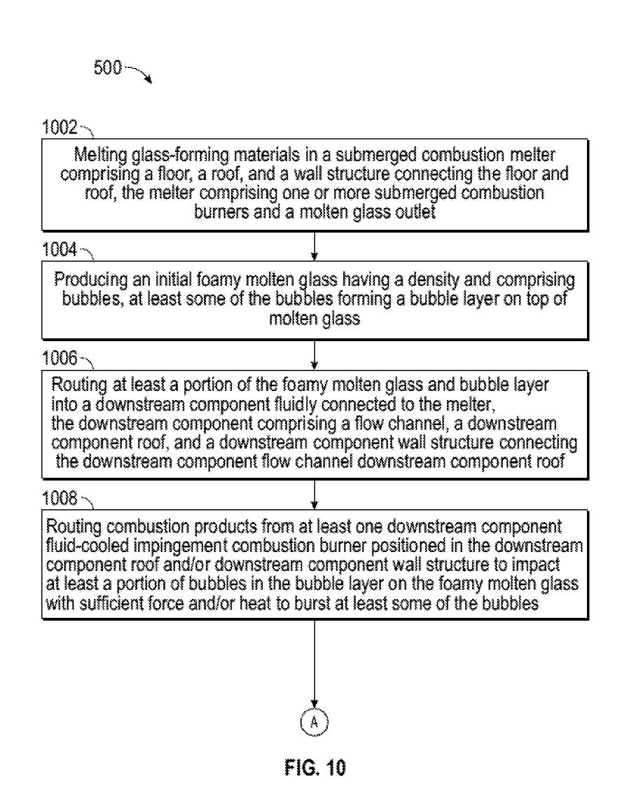

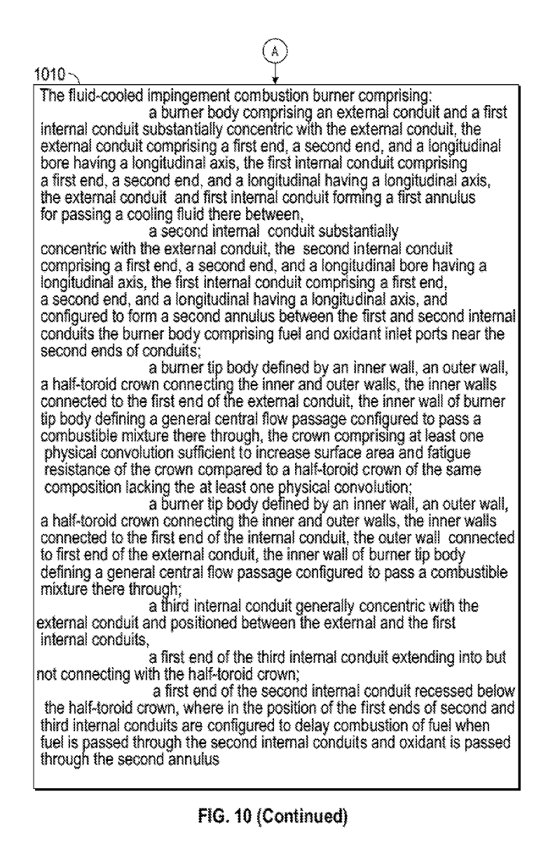

FIGS. 9-10 are logic diagrams of two method embodiments of the present disclosure. FIG. 9 is a logic diagram of method embodiment 450, including the steps of melting glass-forming materials in a submerged combustion melter comprising a floor, a roof, and a wall structure connecting the floor and roof, the melter comprising one or more submerged combustion burners and a molten glass outlet (box 902); producing an initial foamy molten glass having a density and comprising bubbles, at least some of the bubbles forming a bubble layer on top of the foamy molten glass. (box 904); routing at least a portion of the foamy molten glass and bubble layer into a downstream component fluidly connected to the melter, the downstream component comprising a flow channel, a downstream component roof, and a downstream component wall structure connecting the downstream component flow channel and downstream component roof (box 906); and routing combustion products from at least one downstream component fluid-cooled impingement combustion burner positioned in the downstream component roof and/or downstream component wall structure to impact at least a portion of bubbles in the bubble layer on the foamy molten glass with sufficient force and/or heat to burst at least some of the bubbles (box 908), wherein the fluid-cooled impingement combustion burner comprises

a burner body comprising an external conduit and a first internal conduit substantially concentric with the external conduit, the external conduit comprising a first end, a second end, and a longitudinal bore having a longitudinal axis, the first internal conduit comprising a first end, a second end, and a longitudinal bore having a longitudinal axis, the external conduit and first internal conduit forming a first annulus for passing a cooling fluid there between,

a second internal conduit substantially concentric with the external conduit, the second internal conduit comprising a first end, a second end, and a longitudinal bore having a longitudinal axis, and configured to form a second annulus between the first and second internal conduits, the burner body comprising fuel and oxidant inlet ports near the second ends of the conduits;

a burner tip body defined by an inner wall, an outer wall, and a half-toroid crown connecting the inner and outer walls, the inner wall connected to the first end of the first internal conduit, the outer wall connected to the first end of the external conduit, the inner wall of the burner tip body defining a generally central flow passage configured to pass a combustible mixture therethrough;

a third internal conduit generally concentric with the external conduit and positioned between the external and the first internal conduits,

a first end of the third internal conduit extending into but not connecting with the half-toroid crown;

a first end of the second internal conduit recessed below the half-toroid crown,

wherein the position of the first ends of the second and third internal conduits are configured to delay combustion of fuel when fuel is passed through the second internal conduit and oxidant is passed through the second annulus (box 910).

FIG. 10 is a logic diagram of method embodiment 500, which is a method comprising the steps of melting glass-forming materials in a submerged combustion melter comprising a floor, a roof, and a wall structure connecting the floor and roof, the melter comprising one or more submerged combustion burners and a molten glass outlet (box 1002); producing an initial foamy molten glass having a density and comprising bubbles, at least some of the bubbles forming a bubble layer on top of the foamy molten glass, (box 1004); routing at least a portion of the foamy molten glass and bubble layer into a downstream component fluidly connected to the melter, the downstream component comprising a flow channel, a downstream component roof, and a downstream component wall structure connecting the downstream component flow channel and downstream component roof. (box 1006); and routing combustion products from at least one downstream component fluid-cooled impingement combustion burner positioned in the downstream component roof and/or downstream component wall structure to impact at least a portion of bubbles in the bubble layer on the foamy molten glass with sufficient force and/or heat to burst at least some of the bubbles (box 1008), wherein the fluid-cooled impingement combustion burner comprises:

a burner body comprising an external conduit and a first internal conduit substantially concentric with the external conduit, the external conduit comprising a first end, a second end, and a longitudinal bore having a longitudinal axis, the first internal conduit comprising a first end, a second end, and a longitudinal bore having a longitudinal axis, the external conduit and first internal conduit forming a first annulus for passing a cooling fluid there between,

a second internal conduit substantially concentric with the external conduit, the second internal conduit comprising a first end, a second end, and a longitudinal bore having a longitudinal axis, and configured to form a second annulus between the first and second internal conduits, the burner body comprising fuel and oxidant inlet ports near the second ends of the conduits;

a burner tip body defined by an inner wall, an outer wall, and a half-toroid crown connecting the inner and outer walls, the inner wall connected to the first end of the first internal conduit, the outer wall connected to the first end of the external conduit, the inner wall of the burner tip body defining a generally central flow passage configured to pass a combustible mixture therethrough, the crown comprising at least one physical convolution sufficient to increase surface area and fatigue resistance of the crown compared to a half-toroid crown of the same composition lacking the at least one physical convolution;

a third internal conduit generally concentric with the external conduit and positioned between the external and the first internal conduits,

a first end of the third internal conduit extending into but not connecting with the half-toroid crown;

a first end of the second internal conduit recessed below the half-toroid crown,

wherein the position of the first ends of the second and third internal conduits are configured to delay combustion of fuel when fuel is passed through the second internal conduit and oxidant is passed through the second annulus (box 1010).

Submerged combustion melter 310 in embodiments described herein may be any of the currently known submerged combustion melter designs, or may be one of those described in Applicant's U.S. Pat. No. 8,769,992, incorporated herein by reference. Submerged combustion melters useful in the practice of the methods and apparatus of this description may take any number of forms, including those described in Applicant's U.S. Pat. No. 8,769,992, which describes sidewalls forming an expanding melting zone formed by a first trapezoidal region, and a narrowing melting zone formed by a second trapezoidal region, wherein a common base between the trapezoid defines the location of the maximum width of the melter. Submerged combustion melter 310 may include a roof, side walls, a floor or bottom, one or more submerged combustion burners, an exhaust chute, one or more molten glass outlets, and optionally fluid-cooled panels comprising some or all of the side walls. Submerged combustion melter 310 is typically supported on a plant floor.

Submerged combustion melter 310 may be fed a variety of feed materials by one or more roll stands, which in turn supports one or more rolls of glass mat, as described in Applicant's U.S. Pat. No. 8,650,914. In certain embodiments powered nip rolls may include cutting knives or other cutting components to cut or chop the mat (or roving, in those embodiments processing roving) into smaller length pieces prior to entering melter 310. Also provided in certain embodiments may be a glass batch feeder. Glass batch feeders are well-known in this art and require no further explanation. Certain embodiments may comprise a process control scheme for the submerged combustion melter and burners. For example, as explained in the '914 patent, a master process controller may be configured to provide any number of control logics, including feedback control, feed-forward control, cascade control, and the like. The disclosure is not limited to a single master process controller, as any combination of controllers could be used. The term “control”, used as a transitive verb, means to verify or regulate by comparing with a standard or desired value. Control may be closed loop, feedback, feed-forward, cascade, model predictive, adaptive, heuristic and combinations thereof. The term “controller” means a device at least capable of accepting input from sensors and meters in real time or near-real time, and sending commands directly to burner control elements, and/or to local devices associated with burner control elements and glass mat feeding devices able to accept commands. A controller may also be capable of accepting input from human operators; accessing databases, such as relational databases; sending data to and accessing data in databases, data warehouses or data marts; and sending information to and accepting input from a display device readable by a human. A controller may also interface with or have integrated therewith one or more software application modules, and may supervise interaction between databases and one or more software application modules. The controller may utilize Model Predictive Control (MPC) or other advanced multivariable control methods used in multiple input/multiple output (MIMO) systems. As mentioned previously, the methods of Applicant's U.S. Pat. No. 8,973,400, using the vibrations and oscillations of the melter itself, may prove useful predictive control inputs.

Those having ordinary skill in this art will appreciate that there are many possible variations of the melter, channels, burners, and adjustment mechanisms to adjust combustion product direction described herein, and will be able to devise alternatives and improvements to those described herein that are nevertheless considered to be within the claims of the present patent.

Submerged combustion burners useful in the SC melter apparatus described herein include those described in U.S. Pat. Nos. 4,539,034; 3,170,781; 3,237,929; 3,260,587; 3,606,825; 3,627,504; 3,738,792; 3,764,287; and 7,273,583, and Applicant's U.S. Pat. No. 8,875,544. One useful burner, for example, is described in the '583 patent as comprising a method and apparatus providing heat energy to a bath of molten material and simultaneously creating a well-mixed molten material. The burner functions by firing a burning gaseous or liquid fuel-oxidant mixture into a volume of molten material. The burners described in the '583 patent provide a stable flame at the point of injection of the fuel-oxidant mixture into the melt to prevent the formation of frozen melt downstream as well as to prevent any resultant explosive combustion; constant, reliable, and rapid ignition of the fuel-oxidant mixture such that the mixture burns quickly inside the molten material and releases the heat of combustion into the melt; and completion of the combustion process in bubbles rising to the surface of the melt. In one embodiment, the burners described in the '583 patent comprises an inner fluid supply tube having a first fluid inlet end and a first fluid outlet end and an outer fluid supply tube having a second fluid inlet end and a second fluid outlet end coaxially disposed around the inner fluid supply tube and forming an annular space between the inner fluid supply tube and the outer fluid supply tube. A burner nozzle is connected to the first fluid outlet end of the inner fluid supply tube. The outer fluid supply tube is arranged such that the second fluid outlet end extends beyond the first fluid outlet end, creating, in effect, a combustion space or chamber bounded by the outlet to the burner nozzle and the extended portion of the outer fluid supply tube. The burner nozzle is sized with an outside diameter corresponding to the inside diameter of the outer fluid supply tube and forms a centralized opening in fluid communication with the inner fluid supply tube and at least one peripheral longitudinally oriented opening in fluid communication with the annular space between the inner and outer fluid supply tubes. In certain embodiments, a longitudinally adjustable rod is disposed within the inner fluid supply tube having one end proximate the first fluid outlet end. As the adjustable rod is moved within the inner fluid supply tube, the flow characteristics of fluid through the inner fluid supply tube are modified. A cylindrical flame stabilizer element is attached to the second fluid outlet end. The stable flame is achieved by supplying oxidant to the combustion chamber through one or more of the openings located on the periphery of the burner nozzle, supplying fuel through the centralized opening of the burner nozzle, and controlling the development of a self-controlled flow disturbance zone by freezing melt on the top of the cylindrical flame stabilizer element. The location of the injection point for the fuel-oxidant mixture below the surface of the melting material enhances mixing of the components being melted and increases homogeneity of the melt. Thermal NOₓ emissions are greatly reduced due to the lower flame temperatures resulting from the melt-quenched flame and further due to insulation of the high temperature flame from the atmosphere.

In certain embodiments the SC burners may be floor-mounted burners. In certain embodiments, the SC burners may be positioned in rows substantially perpendicular to the longitudinal axis (in the melt flow direction) of melter 310. In certain embodiments, the SC burners may be positioned to emit combustion products into molten glass in a melting zone of melter 310 in a fashion so that the gases penetrate the melt generally perpendicularly to the floor. In other embodiments, one or more burners may emit combustion products into the melt at an angle to the floor, as taught in Applicant's U.S. Pat. No. 8,769,992.

Submerged combustion melters useful in systems and methods in accordance with the present disclosure may also comprise one or more wall-mounted submerged combustion burners, and/or one or more roof-mounted non-impingement burners. Roof-mounted non-impingement burners may be useful to pre-heat the melter apparatus melting zone, and serve as ignition sources for one or more submerged combustion burners. Melters having only wall-mounted, submerged-combustion burners are also considered within the present disclosure. Roof-mounted burners may be oxy-fuel burners, but as they are only used in certain situations, are more likely to be air/fuel burners. Most often they would be shut-off after pre-heating the melter and/or after starting one or more submerged combustion burners. In certain embodiments, if there is a possibility of carryover of particles to the exhaust, one or more roof-mounted burners could be used to form a curtain to prevent particulate carryover. In certain embodiments, all submerged combustion burners are oxy/fuel burners (where “oxy” means oxygen, or oxygen-enriched air, as described earlier), but this is not necessarily so in all embodiments; some or all of the submerged combustion burners may be air/fuel burners. Furthermore, heating may be supplemented by electrical heating in certain melter embodiments, in certain melter zones, and in the lehr. In certain embodiments the oxy-fuel burners may comprise one or more submerged combustion burners each having co-axial fuel and oxidant tubes forming an annular space there between, wherein the outer tube extends beyond the end of the inner tube, as taught in U.S. Pat. No. 7,273,583, incorporated herein by reference. Burners may be flush-mounted with the melter floor in certain embodiments. In other embodiments, such as disclosed in the '583 patent, a portion of one or more of the burners may extend slightly into the melt above the melter floor.

In certain embodiments, melter side walls may have a free-flowing form, devoid of angles. In certain other embodiments, side walls may be configured so that an intermediate location may comprise an intermediate region of melter 310 having constant width, extending from a first trapezoidal region to the beginning of a narrowing melting region. Other embodiments of suitable melters are described in the above-mentioned '992 patent.

As mentioned herein, useful melters may include refractory fluid-cooled panels. Liquid-cooled panels may be used, having one or more conduits or tubing therein, supplied with liquid through one conduit, with another conduit discharging warmed liquid, routing heat transferred from inside the melter to the liquid away from the melter. Liquid-cooled panels may also include a thin refractory liner, which minimizes heat losses from the melter, but allows formation of a thin frozen glass shell to form on the surfaces and prevent any refractory wear and associated glass contamination. Other useful cooled panels include air-cooled panels, comprising a conduit that has a first, small diameter section, and a large diameter section. Warmed air transverses the conduits such that the conduit having the larger diameter accommodates expansion of the air as it is warmed. Air-cooled panels are described more fully in U.S. Pat. No. 6,244,197. In certain embodiments, the refractory fluid cooled-panels are cooled by a heat transfer fluid selected from the group consisting of gaseous, liquid, or combinations of gaseous and liquid compositions that functions or is capable of being modified to function as a heat transfer fluid. Gaseous heat transfer fluids may be selected from air, including ambient air and treated air (for air treated to remove moisture), inert inorganic gases, such as nitrogen, argon, and helium, inert organic gases such as fluoro-, chloro- and chlorofluorocarbons, including perfluorinated versions, such as tetrafluoromethane, and hexafluoroethane, and tetrafluoroethylene, and the like, and mixtures of inert gases with small portions of non-inert gases, such as hydrogen. Heat transfer liquids may be selected from inert liquids which may be organic, inorganic, or some combination thereof, for example, salt solutions, glycol solutions, oils and the like. Other possible heat transfer fluids include steam (if cooler than the oxygen manifold temperature), carbon dioxide, or mixtures thereof with nitrogen. Heat transfer fluids may be compositions comprising both gas and liquid phases, such as the higher chlorofluorocarbons.

The refractory or refractory-lined channels or troughs described in accordance with the present disclosure may be constructed using refractory cooled panels. Both the melter and flow channel floors and side walls may include a thin refractory lining, as discussed herein. The thin refractory coating may be 1 centimeter, 2 centimeters, 3 centimeters or more in thickness, however, greater thickness may entail more expense without resultant greater benefit. The refractory lining may be one or multiple layers. Alternatively, melters and channels described herein may be constructed using cast concretes such as disclosed in U.S. Pat. No. 4,323,718. The thin refractory linings discussed herein may comprise materials described in the '718 patent. Two cast concrete layers are described in the '718 patent, the first being a hydraulically setting insulating composition (for example, that known under the trade designation CASTABLE BLOC-MIX-G, a product of Fleischmann Company, Frankfurt/Main, Federal Republic of Germany). This composition may be poured in a form of a wall section of desired thickness, for example a layer 5 cm thick, or 10 cm, or greater. This material is allowed to set, followed by a second layer of a hydraulically setting refractory casting composition (such as that known under the trade designation RAPID BLOCK RG 158, a product of Fleischmann company, Frankfurt/Main, Federal Republic of Germany) may be applied thereonto. Other suitable materials for the refractory cooled panels, melter and channel refractory liners, and refractory block burners (if used) are fused zirconia (ZrO₂), fused cast AZS (alumina-zirconia-silica), rebonded AZS, or fused cast alumina (Al₂O₃). The choice of a particular material is dictated among other parameters by the melter geometry and type of glass to be produced.

The total quantities of fuel and oxidant used by the fluid-cooled impingement burners in systems of the present disclosure may be such that the flow of oxygen may range from about 1.2 to about 2.0 or more of the theoretical stoichiometric flow of oxygen necessary to obtain the complete combustion of the fuel flow. Another expression of this statement is that the combustion ratio may range from about 1.2 to about 2.0. In certain embodiments, the equivalent fuel content of the feed material must be taken into account. For example, organic binders in glass fiber mat scrap materials will increase the oxidant requirement above that required strictly for fuel being combusted. In consideration of these embodiments, the combustion ratio may be increased above 1.2, for example to 1.5, or to 2, or 2.5, or even higher, depending on the organic content of the feed materials.

The ratio of velocity of the fuel to velocity of oxidant is an important parameter in the various fluid-cooled impingement burners and depends on the burner geometry used, but generally is about 0.5 or less, or 0.4 or less, or 0.3 or less. In certain embodiments, the first and second internal conduits may have internal and external radii selected such that a velocity ratio of fuel to oxidant ranges from about 0.5 to about 0.05, or from about 0.4 to about 0.1, or from about 0.3 to about 0.1, when fuel is directed through the second internal conduit and oxidant is directed through the second annulus, and the oxidant experiences a flow that is turbulent. If the oxidant velocity is too low, the flame or combustion products may not be adequate to suppress bubbles or suppress formation of accretions on the burner tip. If the fuel flow is too high, the combustion ratio may be too low, forming soot and other undesirable components that may be added to the molten material in the flow channel. While this is not a great concern in the melter (SCM) since the very turbulent nature of the SCM is able to consume the fuel, even particulate fuels, it is undesirable to disturb the composition of the molten material in a flow channel, such as a conditioning channel.

For fluid-cooled impingement burners burning natural gas, the fluid-cooled impingement burners may have a fuel firing rate ranging from about 5 to about 300 scfh (from about 141.5 L/hr. to about 8,500 L/hr.); an oxygen firing rate ranging from about 10 to about 800 scfh (from about 283 L/hr. to about 22,650 L/hr.); a combustion ratio ranging from about 1.5 to about 2.5; nozzle velocity ratio (ratio of velocity of fuel to oxygen at the fuel nozzle tip) ranging from about 1.5 to 2.0, or from about 1.6 to about 1.9. Of course these numbers depend on the heating value of the fuel, amount of oxygen in the “oxygen” stream, temperatures and pressures of the fuel and oxidant, and the like, among other parameters. In one typical operation, the fluid-cooled impingement burners burner would have a combustion ration of 2.5:1; a velocity ratio of 1.7; firing rate of natural gas of 36 scfh (1,020 L/hr.) and 90 scfh (2,550 L/hr.) oxygen; natural gas velocity of 79 ft./sec (24.1 m/sec) and oxygen velocities of 46 ft./sec (14 m/sec); natural gas pressure of 1 psig (6.9 KPa); and oxygen pressure of 0.6 psig (4.1 KPa), pressures measured at the entrance to the combustion chamber.

When in alloyed form, alloys of two or more noble metals may have any range of noble metals. For example, alloys of two noble metals may have a range of about 0.01 to about 99.99 percent of a first noble metal and 99.99 to 0.01 percent of a second noble metal. Any and all ranges in between 0 and 99.99 percent first noble metal and 99.99 and 0 percent second noble metal are considered within the present disclosure, including 0 to about 99 percent of first noble metal; 0 to about 98 percent; 0 to about 97 percent; 0 to about 96; 0 to about 95; 0 to about 90; 0 to about 80; 0 to about 75; 0 to about 70; 0 to about 65; 0 to about 60; 0 to about 55; 0 to about 50; 0 to about 45, 0 to about 40; 0 to about 35; 0 to about 30; 0 to about 25; 0 to about 20; 0 to about 19; 0 to about 18; 0 to about 17; 0 to about 16; 0 to about 15; 0 to about 14; 0 to about 13; 0 to about 12; 0 to about 11 ; 0 to about 10; 0 to about 9; 0 to about 8; 0 to about 7; 0 to about 6; 0 to about 5; 0 to about 4; 0 to about 3; 0 to about 2; 0 to about 1; and 0 to about 0.5 percent of a first noble metal; with the balance comprising a second noble metal, or consisting essentially of (or consisting of) a second noble metal (for example with one or more base metals present at no more than about 10 percent, or no more than about 9 percent base metal, or no more than about 8, or about 7, or about 6, or about 5, or about 4, or about 3, or about 2, or no more than about 1 percent base metal).

In certain noble metal alloy embodiments comprising three or more noble metals, the percentages of each individual noble metal may range from equal amounts of all noble metals in the composition (about 33.33 percent of each), to compositions comprising, or consisting essentially of, or consisting of 0.01 percent of a first noble metal, 0.01 percent of a second noble metal, and 99.98 percent of a third noble metal. Any and all ranges in between about 33.33 percent of each, and 0.01 percent of a first noble metal, 0.01 percent of a second noble metal, and 99.98 percent of a third noble metal, are considered within the present disclosure.

Embodiments disclosed herein include:

A: A fluid cooled impingement combustion burner comprising:

a burner body comprising an external conduit and a first internal conduit substantially concentric with the external conduit, the external conduit comprising a first end, a second end, and a longitudinal bore having a longitudinal axis, the first internal conduit comprising a first end, a second end, and a longitudinal bore having a longitudinal axis, the external conduit and first internal conduit forming a first annulus for passing a cooling fluid there between,

a second internal conduit substantially concentric with the external conduit, the second internal conduit comprising a first end, a second end, and a longitudinal bore having a longitudinal axis, and configured to form a second annulus between the first and second internal conduits, the burner body comprising fuel and oxidant inlet ports near the second ends of the conduits;

a burner tip body defined by an inner wall, an outer wall, and a half-toroid crown connecting the inner and outer walls, the inner wall connected to the first end of the first internal conduit, the outer wall connected to the first end of the external conduit, the inner wall of the burner tip body defining a generally central flow passage configured to pass a combustible mixture therethrough; and

a third internal conduit generally concentric with the external conduit and positioned between the external and the first internal conduits,

a first end of the third internal conduit extending into but not connecting with the half-toroid crown;

a first end of the second internal conduit recessed below the half-toroid crown,

wherein the position of the first ends of the second and third internal conduits are configured to delay combustion of fuel when fuel is passed through the second internal conduit and oxidant is passed through the second annulus.

B: A fluid-cooled impingement combustion burner comprising:

a burner body comprising an external conduit and a first internal conduit substantially concentric with the external conduit, the external conduit comprising a first end, a second end, and a longitudinal bore having a longitudinal axis, the first internal conduit comprising a first end, a second end, and a longitudinal bore having a longitudinal axis, the external conduit and first internal conduit forming a first annulus for passing a cooling fluid there between,

a second internal conduit substantially concentric with the external conduit, the second internal conduit comprising a first end, a second end, and a longitudinal bore having a longitudinal axis, and configured to form a second annulus between the first and second internal conduits, the burner body comprising fuel and oxidant inlet ports near the second ends of the conduits;

a burner tip body defined by an inner wall, an outer wall, and a half-toroid crown connecting the inner and outer walls, the inner wall connected to the first end of the first internal conduit, the outer wall connected to the first end of the external conduit, the inner wall of the burner tip body defining a generally central flow passage configured to pass a combustible mixture therethrough, the crown comprising at least one physical convolution sufficient to increase surface area and fatigue resistance of the crown compared to a half-toroid crown of the same composition lacking the at least one physical convolution;

a third internal conduit generally concentric with the external conduit and positioned between the external and the first internal conduits,

a first end of the third internal conduit extending into but not connecting with the half-toroid crown;

a first end of the second internal conduit recessed below the half-toroid crown,

wherein the position of the first ends of the second and third internal conduits are configured to delay combustion of fuel when fuel is passed through the second internal conduit and oxidant is passed through the second annulus.

Embodiment A may have one or more of the following additional elements in any combination: Element 1: the first end of the second internal conduit is positioned adjacent a position where the inner wall of the half-toroid crown connects with the first end of the first inner conduit. Element 2: the first ends of the first and second internal conduits are positioned identically along the longitudinal axis. Element 3: the half-toroid crown has a height of less than 1 inch, the height measured from where the inner wall is connected to the first end of the first internal conduit, and the outer wall is connected to the first end of the external conduit. Element 4: the first and second internal conduits have internal and external radii selected such that a velocity ratio of fuel to oxidant ranges from about 1.5 to about 2.0 when fuel is directed through the second internal conduit and oxidant is directed through the second annulus. Element 5: the first and second internal conduits have internal and external radii selected such that a velocity ratio of fuel to oxidant is about 1.7 when fuel is directed through the second internal conduit and oxidant is directed through the second annulus, and the oxidant experiences a flow that is turbulent. Element 6: the half-toroid crown has a crown longitudinal cross-section selected from the group consisting of hemispherical, trapezoidal, triangular, inverted triangular, irregular, and rectangular. Element 7: the inner and outer walls of the burner tip body extend beyond the first end of the second internal conduit. Element 8: each conduit consists of a material having a wear rate that is more than noble metals when used in a submerged combustion melter. Element 9: the material is selected from the group consisting of ceramic materials, non-noble metals, and combinations thereof. Element 10: the non-noble metal is carbon steel. Element 11: the external conduit is noble metal and one or more of the inner conduits is a non-noble metal material. Element 12: the external conduit is secured in a burner panel. Element 13: the conduits are configured to be movable axially in unison. Element 14: a system comprising (consisting of, or consisting essentially of) a submerged combustion melter (SCM) fluidly connected to a flow channel downstream of the SCM without any intervening chambers, channels, or devices, except in certain embodiments a melter exit structure and a transition section between the melter exit structure and the flow channel, the flow channel devoid of submerged combustion burners and comprising a floor, a roof, and a sidewall structure connecting the floor and roof defining an internal space, and one or more fluid-cooled impingement combustion burners. Element 15: a method of producing molten inorganic product comprising flowing the molten inorganic product through the flow channel and impinging foam in the flow channel using the one or more fluid-cooled impingement combustion burners.

Embodiment B may have one or more of the following additional elements in any combination: Element 1: the at least one crown physical convolution is selected from the group consisting of at least one generally radial crown physical convolution extending away from the generally central flow passage, and at least one generally non-radial crown physical convolution. Element 2: the at least one generally non-radial crown physical convolution is selected from the group consisting of at least one generally circumferential crown physical convolution, a generally spiral crown physical convolution, at least one randomly positioned convolution, and at least one non-randomly positioned convolution. Element 3: the burner tip body crown comprises a plurality of generally radial physical convolutions extending away from the generally central flow passage. Element 4: the plurality of generally radial physical convolutions forms a series of alternating ridges and troughs. Element 5: the crown half-toroid has a crown longitudinal cross-section selected from the group consisting of hemispherical, trapezoidal, triangular, inverted triangular, irregular, and rectangular. Element 6 the series of alternating ridges and troughs form a crown radial cross-section selected from the group consisting of, hemispherical, trapezoidal, triangular, sinusoidal, irregular, rectangular, and sawtooth. Element 7: the at least one randomly positioned convolution comprises a plurality of randomly spaced and randomly shaped depressions. Element 8: the at least one non-randomly positioned convolution comprises a plurality of non-randomly spaced and non-randomly shaped depressions selected from the group consisting of a single row of oblique oval depressions, a single row of chevron depressions, a double row of oblique oval depressions, and combinations thereof. Element 9: the at least one generally circumferential crown physical convolution comprises at least one convolution positioned at the connection of the burner tip body to the external and first internal conduits. Element 10: the inner and outer walls of the burner tip body extend beyond the first end of the second internal conduit. Element 11: the first end of the second internal conduit is positioned adjacent a position where the inner wall of the half-toroid crown connects with the first end of the first inner conduit. Element 12: the first ends of the first and second internal conduits are positioned identically along the longitudinal axis. Element 13: the half-toroid crown has a height of less than 1 inch, the height measured from where the inner wall is connected to the first end of the first internal conduit, and the outer wall is connected to the first end of the external conduit. Element 14: Element 15: the half-toroid crown has a crown longitudinal cross-section selected from the group consisting of hemispherical, trapezoidal, triangular, inverted triangular, irregular, and rectangular. Element 16: the inner and outer walls of the burner tip body extend beyond the first end of the second internal conduit. Element 17: each conduit consists of a material having a wear rate that is more than noble metals when used in a submerged combustion melter. Element 18: the material is selected from the group consisting of ceramic materials, non-noble metals, and combinations thereof. Element 19: the non-noble metal is carbon steel. Element 20: the external conduit is noble metal and one or more of the inner conduits is a non-noble metal material. Element 21: the external conduit is secured in a burner panel. Element 22: the conduits are configured to be movable axially in unison. Element 23: a system comprising (consisting of, or consisting essentially of) a submerged combustion melter (SCM) fluidly connected to a flow channel downstream of the SCM without any intervening chambers, channels, or devices, except in certain embodiments a melter exit structure and a transition section between the melter exit structure and the flow channel, the flow channel devoid of submerged combustion burners and comprising a floor, a roof, and a sidewall structure connecting the floor and roof defining an internal space, and one or more fluid-cooled impingement combustion burners. Element 24: a method of producing molten inorganic product comprising flowing the molten inorganic product through the flow channel and impinging foam in the flow channel using the one or more fluid-cooled impingement combustion burners.

Although only a few exemplary embodiments of this disclosure have been described in detail above, those skilled in the art will readily appreciate that many modifications are possible in the exemplary embodiments without materially departing from the novel apparatus and processes described herein. Accordingly, all such modifications are intended to be included within the scope of this disclosure as defined in the following claims. In the claims, no clauses are intended to be in the means-plus-function format allowed by 35 U.S.C. § 112(f) unless “means for” is explicitly recited together with an associated function. “Means for” clauses are intended to cover the structures described herein as performing the recited function and not only structural equivalents, but also equivalent structures.

What is claimed is:

1. A fluid-cooled impingement combustion burner comprising:
a burner body comprising an external conduit and a first internal conduit substantially concentric with the external conduit, the external conduit comprising a first end, a second end, and a longitudinal bore having a longitudinal axis, the first internal conduit comprising a first end, a second end, and a longitudinal bore having a longitudinal axis, the external conduit and first internal conduit forming a first annulus for passing a cooling fluid there between,
a second internal conduit substantially concentric with the external conduit, the second internal conduit comprising a first end, a second end, and a longitudinal bore having a longitudinal axis, and configured to form a second annulus between the first and second internal conduits, the burner body comprising fuel and oxidant inlet ports near the second ends of the conduits;
a burner tip body defined by an inner wall, an outer wall, and a half-toroid crown connecting the inner and outer walls, the inner wall connected to the first end of the first internal conduit, the outer wall connected to the first end of the external conduit, the inner wall of the burner tip body defining a generally central flow passage configured to pass a combustible mixture therethrough;
a third internal conduit generally concentric with the external conduit and positioned between the external and the first internal conduits,
a first end of the third internal conduit extending into but not connecting with the half-toroid crown;
a first end of the second internal conduit recessed below the half-toroid crown,
wherein the position of the first ends of the second and third internal conduits are configured to delay combustion of fuel when fuel is passed through the second internal conduit and oxidant is passed through the second annulus.

2. The fluid-cooled impingement combustion burner of claim 1 wherein the first end of the second internal conduit is positioned adjacent a position where the inner wall of the half-toroid crown connects with the first end of the first inner conduit.

3. The fluid-cooled impingement combustion burner of claim 1 wherein the first ends of the first and second internal conduits are positioned identically along the longitudinal axis.

4. The fluid-cooled impingement combustion burner of claim 3 wherein the half-toroid crown has a height of less than 1 inch, the height measured from where the inner wall is connected to the first end of the first internal conduit, and the outer wall is connected to the first end of the external conduit.

5. The fluid-cooled impingement combustion burner of claim 1 wherein the first and second internal conduits have internal and external radii selected such that a velocity ratio of fuel to oxidant ranges from about 1.5 to about 2.0 when fuel is directed through the second internal conduit and oxidant is directed through the second annulus.

6. The fluid-cooled impingement combustion burner of claim 1 wherein the first and second internal conduits have internal and external radii selected such that a velocity ratio of fuel to oxidant is about 1.7 when fuel is directed through the second internal conduit and oxidant is directed through the second annulus, and the oxidant experiences a flow that is turbulent.

7. The fluid-cooled impingement combustion burner of claim 1 wherein the half-toroid crown has a crown longitudinal cross-section selected from the group consisting of hemispherical, trapezoidal, triangular, inverted triangular, irregular, and rectangular.

8. The fluid-cooled impingement combustion burner of claim 1 wherein the inner and outer walls of the burner tip body extend beyond the first end of the second internal conduit.

9. The fluid-cooled impingement combustion burner of claim 1 wherein each conduit consists of a material having a wear rate that is more than noble metals when used in a submerged combustion melter.

10. The fluid-cooled impingement combustion burner of claim 8 wherein the material is selected from the group consisting of ceramic materials, non-noble metals, and combinations thereof.

11. The fluid-cooled impingement combustion burner of claim 9 wherein the non-noble metal is carbon steel.

12. The fluid-cooled impingement combustion burner of claim 1 comprising wherein the external conduit is noble metal and one or more of the inner conduits is a non-noble metal material.

13. The fluid-cooled impingement combustion burner of claim 1 wherein the external conduit is secured in a burner panel.

14. The fluid-cooled impingement combustion burner of claim 1 wherein the conduits are configured to be movable axially in unison.

15. A fluid-cooled impingement combustion burner comprising:
a burner body comprising an external conduit and a first internal conduit substantially concentric with the external conduit, the external conduit comprising a first end, a second end, and a longitudinal bore having a longitudinal axis, the first internal conduit comprising a first end, a second end, and a longitudinal bore having a longitudinal axis, the external conduit and first internal conduit forming a first annulus for passing a cooling fluid there between,
a second internal conduit substantially concentric with the external conduit, the second internal conduit comprising a first end, a second end, and a longitudinal bore having a longitudinal axis, and configured to form a second annulus between the first and second internal conduits, the burner body comprising fuel and oxidant inlet ports near the second ends of the conduits;
a burner tip body defined by an inner wall, an outer wall, and a half-toroid crown connecting the inner and outer walls, the inner wall connected to the first end of the first internal conduit, the outer wall connected to the first end of the external conduit, the inner wall of the burner tip body defining a generally central flow passage configured to pass a combustible mixture therethrough, the crown comprising at least one physical convolution sufficient to increase surface area and fatigue resistance of the crown compared to a half-toroid crown of the same composition lacking the at least one physical convolution;
a third internal conduit generally concentric with the external conduit and positioned between the external and the first internal conduits,
a first end of the third internal conduit extending into but not connecting with the half-toroid crown;
a first end of the second internal conduit recessed below the half-toroid crown,
wherein the position of the first ends of the second and third internal conduits are configured to delay combustion of fuel when fuel is passed through the second internal conduit and oxidant is passed through the second annulus.

16. The fluid-cooled impingement combustion burner of claim 15 wherein the at least one crown physical convolution is selected from the group consisting of at least one generally radial crown physical convolution extending away from the generally central flow passage, and at least one generally non-radial crown physical convolution.

17. The fluid-cooled impingement combustion burner of claim 16 wherein the at least one generally non-radial crown physical convolution is selected from the group consisting of at least one generally circumferential crown physical convolution, a generally spiral crown physical convolution, at least one randomly positioned convolution, and at least one non-randomly positioned convolution.

18. The fluid-cooled impingement combustion burner of claim 16 wherein the burner tip body crown comprises a plurality of generally radial physical convolutions extending away from the generally central flow passage.

19. The fluid-cooled impingement combustion burner of claim 18 wherein the plurality of generally radial physical convolutions form a series of alternating ridges and troughs.

20. The fluid-cooled impingement combustion burner of claim 15 wherein the crown half-toroid has a crown longitudinal cross-section selected from the group consisting of hemispherical, trapezoidal, triangular, inverted triangular, irregular, and rectangular.

21. The fluid-cooled impingement combustion burner of claim 19 wherein the series of alternating ridges and troughs form a crown radial cross-section selected from the group consisting of, hemispherical, trapezoidal, triangular, sinusoidal, irregular, rectangular, and sawtooth.

22. The fluid-cooled impingement combustion burner of claim 17 wherein the at least one randomly positioned convolution comprises a plurality of randomly spaced and randomly shaped depressions.

23. The fluid-cooled impingement combustion burner of claim 17 wherein the at least one non-randomly positioned convolution comprises a plurality of non-randomly spaced and non-randomly shaped depressions selected from the group consisting of a single row of oblique oval depressions, a single row of chevron depressions, a double row of oblique oval depressions, and combinations thereof.

24. The fluid-cooled impingement combustion burner of claim 17 wherein the at least one generally circumferential crown physical convolution comprises at least one convolution positioned at the connection of the burner tip body to the external and first internal conduits.

25. The fluid-cooled impingement combustion burner of claim 15 wherein the inner and outer walls of the burner tip body extend beyond the first end of the second internal conduit.

26. A system comprising (consisting of, or consisting essentially of) a submerged combustion melter (SCM) fluidly connected to a flow channel downstream of the SCM (sometimes referred to herein as a conditioning channel) without any intervening chambers, channels, or devices, except in certain embodiments a melter exit structure and a transition section between the melter exit structure and the flow channel, the flow channel devoid of submerged combustion burners and comprising a floor, a roof, and a sidewall structure connecting the floor and roof defining an internal space; and
one or more fluid-cooled impingement combustion burners of claim 1 in either the roof, the sidewall structure, or both.

27. A system comprising (consisting of, or consisting essentially of) a submerged combustion melter (SCM) fluidly connected to a flow channel downstream of the SCM (sometimes referred to herein as a conditioning channel) without any intervening chambers, channels, or devices, except in certain embodiments a melter exit structure and a transition section between the melter exit structure and the flow channel, the flow channel devoid of submerged combustion burners and comprising a floor, a roof, and a sidewall structure connecting the floor and roof defining an internal space; and
one or more fluid-cooled impingement combustion burners of claim 15 in either the roof, the sidewall structure, or both.

28. A method of producing molten inorganic product comprising flowing the molten inorganic product through the flow channel of claim 26 and impinging foam in the flow channel using the one or more fluid-cooled impingement combustion burners.

29. A method of producing molten inorganic product comprising flowing the molten inorganic product through the flow channel of claim 27 and impinging foam in the flow channel using the one or more fluid-cooled impingement combustion burners.

30. A method comprising:
melting glass-forming materials in a submerged combustion melter comprising a floor, a roof, and a wall structure connecting the floor and roof, the melter comprising one or more submerged combustion burners and a molten glass outlet;
producing an initial foamy molten glass having a density and comprising bubbles, at least some of the bubbles forming a bubble layer on top of the foamy molten glass; and
routing at least a portion of the foamy molten glass and bubble layer into a downstream component fluidly connected to the melter, the downstream component comprising a flow channel, a downstream component roof, and a downstream component wall structure connecting the downstream component flow channel and downstream component roof; and
routing combustion products from at least one non-submerged fluid-cooled impingement combustion burner of claim 1 positioned in the downstream component roof and/or downstream component wall structure to impact at least a portion of bubbles in the bubble layer on the foamy molten glass with sufficient force and/or heat to burst at least some of the bubbles.

31. The method of claim 30 comprising adjusting one or more of the fluid-cooled impingement combustion burners with respect to direction of flow of their combustion products.

32. A method comprising:
melting glass-forming materials in a submerged combustion melter comprising a floor, a roof, and a wall structure connecting the floor and roof, the melter comprising one or more submerged combustion burners and a molten glass outlet;
producing an initial foamy molten glass having a density and comprising bubbles, at least some of the bubbles forming a bubble layer on top of the foamy molten glass; and
routing at least a portion of the foamy molten glass and bubble layer into a downstream component fluidly connected to the melter, the downstream component comprising a flow channel, a downstream component roof, and a downstream component wall structure connecting the downstream component flow channel and downstream component roof; and
routing combustion products from at least one non-submerged fluid-cooled impingement combustion burner of claim 14 positioned in the downstream component roof and/or downstream component wall structure to impact at least a portion of bubbles in the bubble layer on the foamy molten glass with sufficient force and/or heat to burst at least some of the bubbles.

33. The method of claim 32 comprising adjusting one or more of the fluid-cooled impingement combustion burners with respect to direction of flow of their combustion products.
